(19) United States
(12) Patent Application Publication
(10) Pub. No.: US 2006/0183009 A1
(43) Pub. Date: Aug. 17, 2006

(54) Fuel cell fuel processor with hydrogen buffering

(76) Inventors: Paul J. Berlowitz, Glen Gardner, NJ (US); Rajeev Agnihotri, Fairfax, VA (US); Frank Hershkowitz, Liberty Corner, NJ (US); Novica S. Rados, Fairfax, VA (US); Jeffrey W. Frederick, Centreville, VA (US)

Correspondence Address: ExxonMobil Research and Engineering Company, P. O. Box 900, Annandale, NJ, 08801-0900, US

(21) Appl. No.: 11/336,208

(22) Filed: Jan. 20, 2006

Related U.S. Application Data
(60) Provisional application No. 60/652,074, filed on Feb. 11, 2005.

(51) Int. Cl. H01M 8/06

(52) U.S. Cl. 429/19; 429/34; 429/17

(57) ABSTRACT

A fuel cell system is provided which includes a hydrocarbon fuel processor for generating hydrogen for use in a fuel cell. The system further includes a hydrogen buffer for storing a portion of the hydrogen generated by the fuel processor. This stored hydrogen may then be used during start-up of the system was number of ways such as feed for the fuel cell, or when the fuel processor output is temporarily less than that required by the operating demand of the fuel cell.

This application claims the benefit of U.S. Provisional Application No. 60/652,074 filed Feb. 11, 2005.

### FIELD OF THE INVENTION

The present invention relates to fuel cell systems incorporating a hydrocarbon fuel processor for generating hydrogen for use in a fuel cell. In particular the present invention provides improvements in the start-up and transient performance of such systems, especially those designed for use in confined space applications such as “on board” vehicle applications.

### BACKGROUND OF THE INVENTION

Hydrogen may be produced from hydrocarbons in a fuel processor such as a steam reformer, a partial oxidation reactor or an auto-thermal reformer and a fuel cell system incorporating such hydrocarbon fuel processors have been proposed.

In the case of a steam reforming, steam is reacted with a hydrocarbon containing feed to produce a hydrogen-rich synthesis gas. The general stoichimetry, illustrated with methane, is:
CH₄+H₂O→CO+3H₂ (1)
Typically an excess of steam is used to drive the equilibrium to the right. As applied to hydrogen manufacture, excess steam also serves to increase the water gas shift reaction:
CO+H₂O→CO₂+H₂ (2)

Because of the high endothermicity of the reaction, steam reforming is typically carried out in catalyst packed tubes positioned within a furnace that occupies a volume of space substantially greater than the tube volume. The large size of such conventional steam reformer is one factor that limits its use in space constrained fuel cell applications such as on board vehicles.

Gas phase partial oxidation of hydrocarbons to produce hydrogen involves feeding a hydrocarbon and sub-stoichiometric oxygen into a burner where they combust to produce a synthesis gas mixture. The ideal gas phase partial oxidation reaction illustrated for methane is:
CH₄+½O₂→CO+2H₂ (3)
However, gas-phase reaction kinetics tend to over-oxidize some of the feed, resulting in excessive heat generation and substantial yield of H₂O, CO₂, unreacted hydrocarbons and soot. For these reasons when gas phase partial oxidation chemistry is applied to clean feeds, it is preferred to add steam to the feed and add a bed of steam reforming catalyst to the gas phase partial oxidation reactor vessel. This combination of gas phase partial oxidation and steam reforming is called autothermal reforming.

In autothermal reforming processes a source of oxygen such as air is employed which results in a nitrogen-diluted synthesis gas that renders the gas less suitable for fuel cell use in space constrained applications.

Sederquist (U.S. Pat. Nos. 4,200,682, 4,240,805, 4,293,315, 4,642,272 and 4,816,353) discloses a steam reforming process in which the heat of reforming is provided within a catalyst bed by cycling between combustion and reforming stages of a cycle.

As described by Sederquist, the high quality of heat recovery within the reforming bed results in a theoretical efficiency of about 97%. However, these patents describe a process that operates at very low productivity, with space velocities of around 100 hr⁻¹ (as C₁-equivalent). Moreover, this process requires a compressor to compress the product synthesis gas to elevated pressure. One consequence of Sederquist's low space velocity is that resulting high heat losses impede the ability of this technology to achieve the theoretical high efficiency.

In U.S. patent application Ser. No. 10/756,647 filed Jan. 13, 2004, which is incorporated herein by reference, there is described a fuel cell system which incorporates a highly efficient and highly productive process for producing hydrogen from a hydrocarbon containing fuel called “pressure swing reforming” or “PSR”. PSR is disclosed in published U.S. Patent Application 2003/0235529 filed Jun. 10, 2003 also incorporated herein by reference.

PSR is a cyclic, two step process in which in a first reforming step a hydrocarbon containing feed along with steam is fed into the inlet of a first zone containing reforming catalyst. During the reforming step a temperature gradient across the reforming catalyst has a peak temperature that ranges from about 700° C. to 2000° C. Upon introduction of the reactants, the hydrocarbon is reformed into synthesis gas in the first zone. This reforming step may be performed at a relatively high pressure. The synthesis gas is then passed from the first zone to a second zone where the gas is cooled by transferring its heat to packing material in a second regeneration zone.

The second, regeneration step begins when a gas is introduced into the inlet of the second zone. This gas is heated by the stored heat of the packing material of the recuperation zone. Additionally, an oxygen-containing gas and fuel are combusted near the interface of the two zones, producing a hot flue gas that travels across the first zone, thus reheating that zone to a high enough temperature to reform feed. Once heat regeneration is completed, the cycle is completed and reforming may begin again.

The integration of PSR in a fuel cell system is particularly advantageous because of PSR's efficiency in producing relatively high pressure of hydrogen in a compact space and at a lower reaction cost when compared with other hydrogen generation approaches.

As will be readily appreciated the incorporation of any fuel processing scheme in a fuel cell system that involves converting hydrocarbon fuels to hydrogen for the purpose of fueling a fuel cell, poses problems associated with start-up and transient performance. Clearly, what is desired is the ability to rapidly start-up the reformer as well as provide sufficient hydrogen to the fuel cell so as to perform rapid transients. The present invention is directed toward those needs.

Thus, one object of the present invention is to provide a fuel cell system capable of providing hydrogen fuel to the fuel cell in a manner that provides rapid start-up.

Another object is to provide a fuel cell system incorporating a hydrocarbon fuel processor that permits the fuel cell system to perform any rapid transients.

These and other objectives of the invention will become apparent from the disclosures herein.

### SUMMARY OF THE INVENTION

Simply stated, a fuel cell system is provided comprising:
a fuel cell;
a hydrocarbon fuel processor for generating hydrogen for use in the fuel cell; and
a hydrogen buffer for storing a portion of the hydrogen produced in the fuel processor for use by the system during start-up of the system or when required by the fuel cell during the course of operation of the fuel cell system.

In a preferred embodiment, the hydrocarbon fuel processor is a PSR processor and the system is especially sized and adapted for use in space constrained application such as on-board vehicles.

### BRIEF DESCRIPTION OF THE DRAWINGS

FIG. 1 is a schematic illustration of a fuel cell fuel processor system according to the present invention.

FIGS. 2a and 2b illustrate the basic two-step cycle of pressure scoring reforming.

FIG. 3 is a diagrammatic illustration of pressure swing reforming using a dual bed, valved system.

FIG. 4 is a diagrammatic illustration of a process design using pressure swing reforming for a fuel cell application according to the invention.

FIG. 5 is a diagrammatic illustration of a system according to the inventor using pressure swing reforming, with a shift reaction and hydrogen separation having a hydrogen buffer.

FIG. 6 is a graph illustrating start-up times for a fuel process at various initial sustained fuel cell power outputs.

FIGS. 7 and 8 are graphs illustrating operating principle of the inventors.

### DETAILED DESCRIPTION OF THE INVENTION

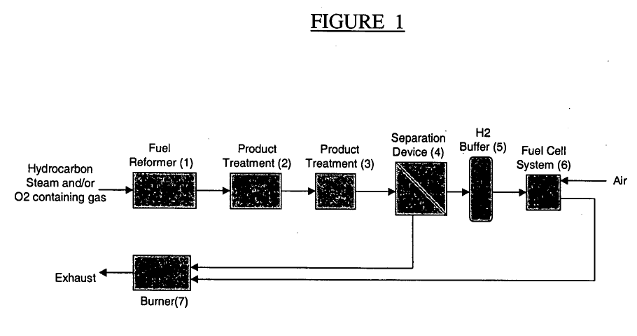

A fuel cell system incorporating a hydrocarbon fuel processor and including a hydrogen buffer according to the invention is schematically illustrated in FIG. 1 along with an optional treatment sequence for the hydrogen rich gas produced in the fuel processor. Thus as shown the system comprises a fuel processor 1,for converting hydrocarbon fuels into a hydrogen rich gas by reacting hydrocarbon fuel with steam, an oxygen containing gas or mixtures thereof. Typically the fuel processor 1 is a steam reformer containing a suitable solid phase steam reforming catalyst. The system may include means for treating the hydrogen rich gas from the processor 1. Because the treatments may involve either chemical reactions, such as the water-gas shift reaction, or physical processing, such as temperature and pressure, or both, the chemical means is shown in FIG. 1 as a product treatment reactor 2 and the physical means as product treatment reactor 3. Product treatment reactor 2 may be a multi-stage water gas shift reactor and product treatment reactor 3 may, for example, encompass a network of heat exchangers. With or without treatment, the hydrogen rich gas is sent to a separator 4 to remove gaseous species other than hydrogen and to provide a stream of substantially pure, i.e., greater than 95%, hydrogen gas. Separation device 4 may be any suitable device known in the art for separating hydrogen from a mixed gas stream such as a membrane separation device or a pressure swing adsorption device. At least a portion of the hydrogen rich gas form the separation device 4 is directed to the hydrogen buffer 5 for storage therein and for subsequent use as a feed to fuel cell 6. The hydrogen stored in buffer 5 may be physically adsorbed on a solid in buffer 5 or may for example by stored as a gas or liquid therein. Because it is preferred that the hydrogen be stored in an easily accessible form it is preferred that the hydrogen be stored as a pressurized gas. In operation, of course, air is supplied to the fuel cell 6 as well as hydrogen. A purge gas stream from separator 4 optionally is fed to a burner 7 to extract heat which can be used within the fuel processor system for better thermal efficiency of the processor 1.

The buffer 5 for storing hydrogen is sized to provide hydrogen to the fuel cell during the start-up phase of the fuel processor. Optionally hydrogen from buffer 5 may also be used as fuel for heating the fuel processor. Additionally the hydrogen stored in buffer 5 may be used to regulate the supply of hydrogen from the fuel processor 1 and the demand from the fuel cell 6.

The size of the buffer is dependent upon the expected amount of hydrogen stored in the buffer and the pressure at which hydrogen is stored. The buffer may be used for providing hydrogen to the fuel cell stack during the start-up period when the fuel reformer is not yet producing hydrogen. Additionally, the buffer may provide hydrogen to the fuel reformer as fuel for burning and heating up the fuel processor components and catalysts. Another optional use of the buffer is to regulate the supply of hydrogen to fuel cell under situations when the demand for hydrogen from the fuel cell and the supply of hydrogen from the fuel reformer are temporarily mismatched.

When the buffer is used to provide hydrogen to a PEM fuel cell while the fuel processor is being started-up, before production of hydrogen from the processor, then the size of the buffer is that which is sufficient to meet the hydrogen needs of the PEM fuel cell during the fuel processor start-up period. For a buffer in the form of a container storing hydrogen as compressed gas at a pressure (P_{b}, in atm), the volume of a buffer (V_{b,start} in liters) may be determined on the basis of the time (tₛₜₐᵣₜ in sec) required to heat-up the fuel processor and start producing hydrogen at the flowrate (f_{H2} in liters/sec) required by the fuel cell operating at a given pressure (P_{fc} in atm). In such a case the volume of the buffer (V_{b,start}, in liters) may be given by:
V_{b,start}=n*f_{H2}* tₛₜₐᵣₜ* P_{fc}/P_{b} (4)

Optionally, the volume of the buffer may be sized on the basis of maximum hydrogen flow rate (f_{H2,max} in liters/sec) required by the fuel cell. In that case V_{b,start max} (in liters) is given by:
V_{b,start max}=n*f_{H2}, max * tₛₜₐᵣₜ* P_{fc}/P_{b} (5)

Optionally, it may be desirable to use some of the hydrogen to do some of the initial heat-up of the fuel processor for start-up. This is typically a fixed amount of hydrogen which can be expressed as a volume (V_{b,burn} in liters) at the buffer pressure (P_{b}, in atm). In this case the buffer size may simply be expressed as
V_{b,totalburn}=n* V_{b,oneburn} (6)

In equations (4), (5) and (6), n is a number greater than or equal to 1 and represents the extent of buffer oversizing. The oversizing may be desired for multiple successive start-ups when the reformer is not on long enough to produce hydrogen.

Optionally, the volume of the buffer may be sized to only supply required flow rates of hydrogen to the fuel cell under conditions when rate of hydrogen generated by the fuel processor (f_{H2,fc} in liters/sec) is temporarily lagging the rate of hydrogen required by the fuel cell (fH2, fc in liters/sec). If the lag period (t_{lag} in sec) varies with the extent of mismatch between the rate of hydrogen demanded and rate of hydrogen product then the volume of the buffer (V_{b,transient} in liters/sec) may be given by:
V_{b,transient}=max(abs(t_{lag}*(f_{H2, fp}−f_{H2, fc})) (7)

The buffer may also be sized to provide hydrogen to the fuel cell while the fuel processor is being started-up in addition to supplying the required flow rates of hydrogen to the fuel cell under conditions when rate of hydrogen generated by the fuel processor is temporarily lagging the rate of hydrogen required by the fuel cell. In such a case, the size of the buffer can be a maximum of the V_{b,start max}+V_{b,totalburn} and V_{b,transient}.

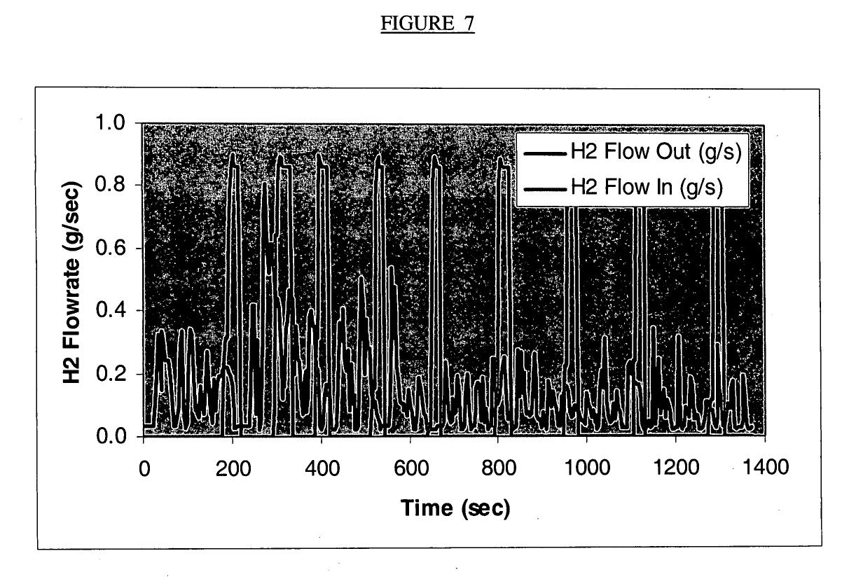

Similar, methodology and logic may be used to determine the amount of hydrogen to be buffered and thus the size of the buffer of type where hydrogen is stored by physically adsorbing hydrogen on a solid. An example of this methodology is shown in Example 1 and FIG. 6.

For space constrained applications such as on-board vehicles it is particularly advantageous for the fuel cell processor 1 to be a PSR.

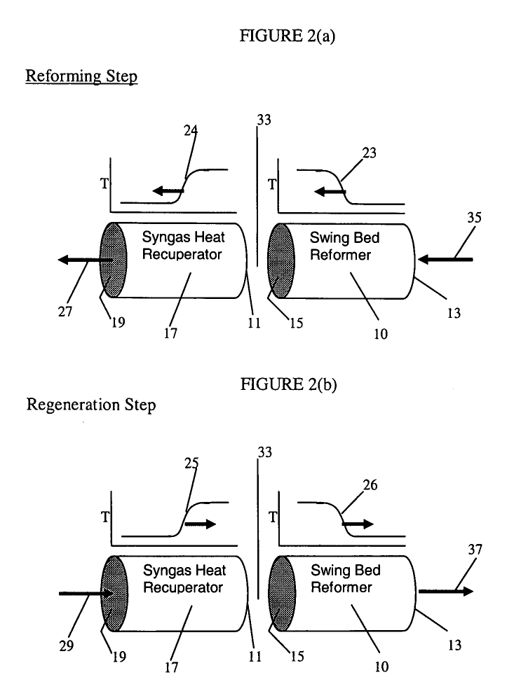

The basic two-step cycle of pressure swing reforming is depicted in FIG. 2. Referring now to FIGS. 2a and 2b, a first zone, or reforming zone 10, called a swing bed reformer, and a second zone, or recuperating zone, called a synthesis gas heat recuperator 17. The beds of both zones will include packing material, while the reforming bed 10 will include catalyst for steam reforming. Though illustrated as separate reforming and recuperating zones, it is to be recognized that the pressure swing reforming apparatus may comprise a single reactor.

As shown in FIG. 2a, at the beginning of the first step of the cycle, also called the reforming step, the reforming zone 10 is at an elevated temperature and the recuperating zone 17 is at a lower temperature than the reforming zone 10. A hydrocarbon-containing feed is introduced via a conduit 15, into a first end 13 of the reforming zone 10 along with steam. The hydrocarbon may be any material that undergoes the endothermic steam reforming reaction including methane, petroleum gases, petroleum distillates, methanol, ethanol and other oxygenates, kerosene, jet fuel, fuel oil, heating oil, diesel fuel and gas oil and gasoline. Preferably the hydrocarbon will be a gaseous material or one which will rapidly become substantially gaseous upon introduction into the reforming zone 10. Preferably, the steam will be present in proportion to the hydrocarbon in an amount that results in a steam to carbon ratio between about 1 and about 3 (considering only carbon in the hydrocarbon, not carbon in CO or CO₂ species that may be present).

This feed stream picks up heat from the bed and is converted over the catalyst and heat to synthesis gas. As this step proceeds, a temperature profile 23 is created based on the heat transfer properties of the system. When the bed is designed with adequate heat transfer capability, as described herein, this profile has a relatively sharp temperature gradient, which gradient will move across the reforming zone 10 as the step proceeds.

Synthesis gas exits the reforming bed 10 through a second end 15 at an elevated temperature and passes through the recuperating zone 17, entering through a first end 11 and exiting at a second end 19. The recuperating zone 17 is initially at a lower temperature than the reforming zone 10. As the synthesis gas passes through the recuperating zone 17, the synthesis gas is cooled to a temperature approaching the temperature of the zone substantially at the second end 19, which is approximately the same temperature as the regeneration feed introduced during the second step of the cycle via conduit 29 (e.g., from about 20° C. to about 600° C.). As the synthesis gas is cooled in the recuperating zone 17, a temperature gradient 24 is created and moves across the recuperating zone 17 during this step.

At the point between steps, the temperature gradients have moved substantially across the reforming zone 10 and the recuperating zone 17. The zones are sized so that the gradients move across both in comparable time during the above reforming step. The recuperating zone 17 is now at the high temperature and the reforming zone 10 is at low temperature, except for the temperature gradient that exists near the exits of the respective zones. The temperature of the reforming zone 10 near the inlet end 13 has now been cooled to a temperature that approaches the temperature of the hydrocarbon feed that has been entering via conduit 35 (e.g., from about 20° C. to about 600° C.).

In the practice of pressure swing reforming, there are alternative means for determining the end of the reforming step. Toward the end of the reforming step, the temperature at end 15 of the reforming zone is reduced and consequently the reforming performance deteriorates below acceptable conversion efficiencies. Reforming performance, as used herein, refers to the conversion of feed hydrocarbons into synthesis gas components of H₂, CO and CO₂. The term percent conversion, as used herein, is calculated as the percent conversion of the carbon in feed hydrocarbonaceous species into synthesis gas species of CO and CO₂. The term unconverted product hydrocarbons, as used herein, refers to product hydrocarbonaceous species that are not synthesis gas components of H₂, CO and CO₂. These typically include product methane, as well as feed hydrocarbons and the cracking products of feed hydrocarbons. The reforming step ends when the reforming performance deteriorates to a level that is below acceptable limits. In practice, optimization of the overall reforming and synthesis gas utilization process will dictate a desired, time-averaged level of reforming conversion. That time-averaged level of reforming conversion is typically greater than 80%, preferably greater than 90%, and most preferably greater than 95%.

The point in time at which the reforming step is ended, and thus the duration of the reforming step, may be chosen (a) as a response to the time-varying performance of the reformer during each reforming step; or (b) based on overall (time-averaged) performance or the system; or (c) fixed as a constant reforming step duration. In embodiment (a), at least one feature of the operation is monitored that is correlated to the reforming performance. This feature may be a composition such as CH₄, H₂, or CO, or alternatively a temperature, such as the temperature at the end 5 of the reforming bed. In one embodiment of the present invention, the reforming step is ended when the temperature at the end 5 of the reforming has decreased to a pre-selected temperature between about 700° C. and about 1200° C. In embodiment (b), the reforming step duration is adjusted based on a measured feature that reflects the overall (time-averaged) performance or the system. This may be an average product composition such as CH₄, H₂, or CO. In one embodiment the present invention, the reforming step duration is adjusted based on the time-averaged concentration of CH₄ in the product, using control strategies known in the art to shorten or lengthen the duration to achieve a predetermined target CH₄ amount. In a preferred embodiment, the target CH₄ amount is set at an amount that represents between about 1% and about 15% of the hydrocarbonaceous feed carbon. In case (c), the reforming step duration is of fixed length, at a value that is predetermined to be acceptable for the space velocity of the operation. In one embodiment the present invention, the reforming step duration is fixed at a duration between about 0.1 seconds and less than about 60 seconds and preferably between about 1.0 and 30 seconds.

After the synthesis gas is collected via an exit conduit 27 at the second end 19 of the recuperating zone 17, the second step of the cycle, also called the regeneration step begins. The regeneration step, illustrated in FIG. 2b, basically involves transferring the heat from the recuperator bed 17 to the reformer bed 10. In so doing, the temperature gradients 25 and 26 move across the beds similar to but in opposite directions to gradients 23 and 24 during reforming. In a preferred embodiment, an oxygen-containing gas and fuel are introduced via a conduit 29 into the second end 19 of the recuperating zone 17. This mixture flows across the recuperating zone 17 and combusts substantially at the interface 33 of the two zones 10 and 17. In the present invention, the combustion occurs at a region proximate to the interface 33 of the recuperation zone 17 and the reforming zone 10. The term, “region proximate”, in the present invention, means the region of the PSR beds in which regeneration step combustion will achieve the following two objectives: (a) the heating of the reforming zone such that end 15 of the reforming zone is at a temperature of at least 800° C., and preferably at least 1000° C. at the end of the regeneration step; and (b) the cooling of the recuperation zone to a sufficient degree that it can perform its function of accepting synthesis gas sensible heat in the subsequent reforming step. Depending on specific regeneration embodiments described herein, the region proximate to the interface can include from 0% to about 50% of the volume of the recuperation zone 17, and can include from 0% to about 50% of the volume of the reforming zone 10. In a preferred embodiment of the present invention, greater than 90% of the regeneration step combustion occurs in a region proximate to the interface, the volume of which region includes less than about 20% the volume of the recuperating zone 17 and less than about 20% the volume of reforming zone 10.

The location of combustion may be fixed by introduction of one of the combustion components, e.g., the fuel, at or substantially at, the interface of the two zones 33, while the other component, e.g., the oxygen-containing gas may be introduced at the first end 19 of the recuperating zone 17. Alternatively, the fuel and oxygen-containing gas 29 streams may be mixed at the open-end 19 of the recuperating zone 17 and travel through the zone and combust at the interface of the zones 33. In this embodiment, the location of combustion is controlled by a combination of temperature, time, fluid dynamics and catalysis. Fuel and oxygen conventionally require a temperature-dependent autoignition time to combust. In one embodiment, the flow of a non-combusting mixture in a first substep of regeneration will set the temperature profile in the recuperating zone 17 such that the zone is not hot enough to ignite until the mixture reaches the interface of the zones.

The presence of catalyst in the reforming zone can also be used to initiate combustion at that location, and a space between the reforming and recuperating zones can be added and designed to further stabilize the combustion process and confine the combustion to the area proximate to the above described interface. In yet another embodiment, the location of combustion is fixed by mechanical design of the recuperating zone. In this design, the fuel and oxygen-containing gas are traveling in separate channels (not shown), which prevent combustion until the feeds combine at the interface of the zones 33. At that location, flame holders (not shown) or a catalyst in the reforming zone will ensure that the combustion occurs.

The combustion of the fuel and oxygen-containing gas creates a hot fluegas that heats the reforming zone 10 as the flue gas travels across that zone. The fluegas then exits through the first end of the reforming zone 13 via a conduit 37. The composition of the oxygen-containing gas/fuel mixture is adjusted to provide the desired temperature of the reforming zone. The composition and hence temperature is adjusted by means of the proportion of combustible to non-combustible portions of the mixture. For example, non-combustible gases such as H₂O, CO₂, and N₂ can be added to the mixture to reduce combustion temperature. In a preferred embodiment, non-combustible gases are obtained by use of steam, flue gas, or oxygen-depleted air as one component of the mixture. When the hot fluegas reaches the temperature gradient within the reformer, the gradient moves further across the bed. The outlet temperature of the fluegas will be substantially equal to the temperature of the reforming zone 10 near the inlet end 13. At the beginning of the regeneration step, this outlet temperature will be substantially equal to the inlet temperature of the reforming feed of the preceding, reforming, step. As the regeneration step proceeds, this outlet temperature will increase slowly and then rapidly as the temperature gradient reaches end 13, and can be 50-500° C. above the temperature of the reforming feed by the end of the step.

In the practice of pressure swing reforming, there are alternative means for determining the end of the regeneration step. The regeneration step ends when sufficient heat has been supplied or conveyed to the reforming bed to enable the carrying out of the reforming step. The point in time at which the regeneration step is ended, and thus the duration of the regeneration step, may be chosen (a) as a response to the time-varying performance of the PSR during each regeneration step; or (b) based on overall (time-averaged) performance or the system; or (c) fixed as a constant regeneration step duration. In embodiment (a), some feature of the operation is monitored that is related to the regeneration performance. This feature could be a composition such as O₂, CH₄, H₂, or CO, or could be a temperature such as the temperature at the end 3 of the reforming bed. In one embodiment of the present invention, the regeneration step is ended when the temperature at the end 3 of the reforming bed has increased to a pre-selected temperature between about 200° C. and about 800° C. In embodiment (b), the regeneration step duration is adjusted based on a measured feature that reflects the overall (time-averaged) performance of the system. This feature may be an average product composition such as CH₄, H₂, or CO, or some other system measurement. In one embodiment of the present invention, the regeneration step duration is adjusted based on the time-averaged concentration of CH₄ in the product, using control strategies known in the art to shorten or lengthen the duration to achieve the target CH₄ amount. In a preferred embodiment, the target CH₄ amount is set at an amount that represents between about 1% and about 15% of the hydrocarbonaceous feed carbon. In embodiment (c), the regeneration step duration is of fixed length, at a value that is predetermined to be acceptable for the space velocity of the operation. In one embodiment the present invention, the regeneration step duration is fixed at a duration between about 0.1 second and about 60 seconds and preferably 1.0-30 seconds. In all of these cases, but particularly in embodiment (c), it is preferable to also adjust the regeneration flow rates to increase or decrease the amount of heat added to the bed during the step—in a manner similar to that described with respect to adjustment of duration in embodiment (b), above. In a further embodiment of the present invention, the regeneration step duration is fixed at a duration between about 1 second and about 60 seconds, and the regeneration flow rate is adjusted over time so that the time-average concentration of CH₄ in the reforming product approaches a target CH₄ amount that is set at an amount that represents between about 1% and about 15% of the hydrocarbonaceous feed carbon.

The reforming zone is now, once again, at reforming temperatures suitable for catalytic reforming.

For fuel cell applications, it is particularly advantageous to produce hydrogen feed streams having relatively high hydrogen partial pressure, and at relatively high space velocities. In pressure swing reforming the two steps of the cycle may be conducted at different pressures, that is, the reforming step may be carried out at higher pressures than the regeneration step. The reforming step pressures range from about zero (0) atmospheres (gauge pressure) to about twenty-five (25) atmospheres (gauge pressure). The term gauge pressure is intended to reflect pressure above atmospheric pressure at the location of operations (e.g., at elevations above sea level, atmospheric pressure may be <101 kPa). Regeneration step pressures range from about zero (0) atmospheres (gauge pressure) to about ten (10) atmospheres (gauge pressure). Unless otherwise stated, pressures are identified in units of gauge pressure. The pressure swing is enabled in principle part to the large volumetric heat capacity difference between the solid bed packing material and the gases.

The space velocity of a system is typically expressed on an hourly basis as the standard volumetric gas flow rate of feed divided by the volume of catalyst bed, called gaseous hourly space velocity, or GHSV. Space velocity can also be defined in terms of the hydrocarbon component of feed. As so defined, the GHSV for a methane feed would be the standard hourly volumetric gas flow rate of methane divided by the bed volume. As used herein, the term space velocity, abbreviated as C₁GHSV, refers to the space velocity of any hydrocarbon feed placed on a C₁ basis. As such, the hydrocarbon feed rate is calculated as a molar rate of carbon feed, and standard volume rate calculated as if carbon is a gaseous species. For example, a gasoline feed having an average carbon number of 7.0 that is flowing at a gaseous flow rate of 1,000 NL/hour into a 1.0 L bed would be said to have a space velocity of 7,000. This definition is based on feed flow during the reforming step and wherein the bed volume includes all catalysts and heat transfer solids in the reforming and recuperating zones.

In pressure swing reforming, the space velocity, C₁GSHSV, typically ranges from about 500 to about 150,000, preferably from about 1,000 to about 100,000, and most preferably from about 2,000 to about 50,000.

In a preferred embodiment pressure swing reforming is conducted under bed packing and space velocity conditions that provide adequate heat transfer rates, as characterized by a heat transfer parameter, ΔT_{HT}, of between about 0.1° C. to about 500° C., and more preferably between about 0.5° C. and 40° C. The parameter ΔT_{HT} is the ratio of the bed-average volumetric heat transfer rate that is needed for reforming, H, to the volumetric heat transfer coefficient of the bed, hᵥ. The volumetric heat transfer rate that is needed for reforming is calculated as the product of the space velocity with the heat of reforming (on heat per C₁ volume basis). For example, H=4.9 cal/cc/s=2.2 cal/cc * 8000 hr⁻¹/3600 s/hr, where 2.2 cal/cc is the heat of reforming of methane per standard volume of methane, and 8000 is the C₁GHSV of methane. When the duration of reform and regeneration steps are comparable, the value of H will be comparable in the two steps. The volumetric heat transfer coefficient of the bed, hᵥ, is known in the art, and is typically calculated as the product of a area-based coefficient (e.g., cal/cm²s° C.) and a specific surface area for heat transfer (aᵥ, e.g. cm²/cm³), often referred to as the wetted area of the packing.

For PSR, reforming step feed temperatures range from about 20° C. to about 600° C., and preferably from about 150° C. to about 450° C. Regeneration feed temperatures are substantially similar, ranging from about 20° C. to about 600° C. and preferably from about 150° C. to about 450° C. Different embodiments for the integration of the PSR with a fuel cell and optional synthesis gas modification and/or separation processes, detailed hereinafter, will have different most-preferred temperatures for PSR feeds. The temporal isolation of the reforming step from the regeneration step provides the opportunity to operate these steps at substantially different pressures, in a way that is advantageous to the PSR/Fuel Cell system. Thus, reforming step pressures for PSR as taught herein range from about zero (0) atmosphere to about twenty five (25) atmospheres, and preferably from about four (4) atmospheres to about fifteen (15) atmospheres. Regeneration step pressures range from about zero atmosphere to about ten (10) atmospheres, and preferably from about zero (0) atmosphere to about four (4) atmospheres. Unless otherwise stated, pressure is expressed in units of gauge pressure.

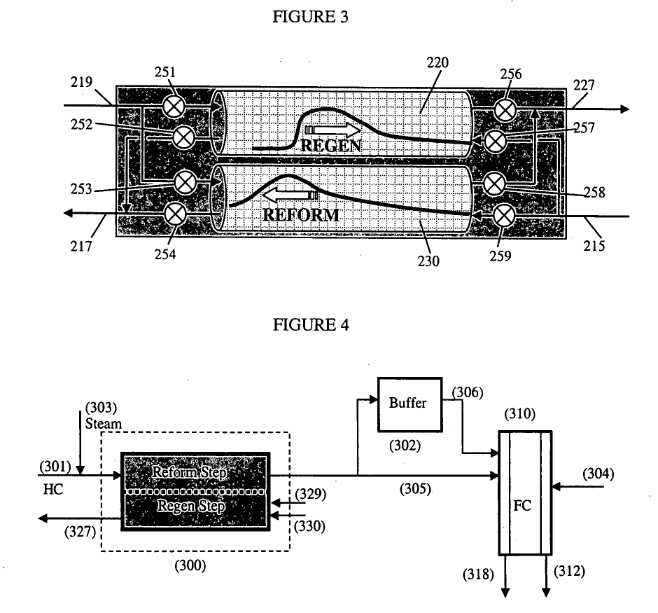

FIG. 3 shows an embodiment of the pressure swing reforming diagrammatically illustrating the cyclic reforming and regeneration process. In this embodiment, two pressure swing reforming bed systems are used simultaneously such that one system is reforming while the other is regenerating. The use of multiple beds can provide a continuous flow of reformed product notwithstanding the cyclical operation of each bed. In FIG. 3, a first bed 220 is engaged in the step of regeneration, while a second bed 230 is engaged in the step of reforming. Each bed (220 and 230) includes both reforming and recuperating zones. In this embodiment, several sets of valves are used to control the various streams flowing to and from the beds. A first set of valves (257 and 259 controls the flow of hydrocarbon feed and steam feed to the beds, while a second set of valves (252 and 254 control the flow of the product of the reforming step exiting the recuperating zones. The third set of valves (251 and 253 regulate the flow of oxygen-containing gas/fuel and optional non-combusting gas to the beds and the fourth set of valves (256 and 258 control the flow of fluegas exiting the reforming zone.

In operation, when valves 251, 254, 256, and 259 are open, valves 252, 253, 257 and 258 are closed. With these valve states, oxygen containing gas and fuel (219) enter the bed (220) through valve 251 while fluegas (227 exits the bed (220) through valve 256. Concurrently, the hydrocarbon and steam feed (215 enters the second bed (230) through valve 259 while the product of reforming (217) exits this bed (230) through valve 254. At the conclusion of this step, valves 252, 253, 257 and 259 now open and valves 251, 254, 256 and 257 now close, and the cycle reverses, with the first bed (220) reforming the feed and the second bed (230) regenerating the heat.

The heat transfer characteristics of the bed packing material are set to enable the high space velocity.

It is well known in the art that bed packing can be characterized for heat transfer coefficient (h) and characterized for heat transfer surface area (often referred to as wetted area, aᵥ). Correlations for these parameters, based on gas and solid properties, are well known. The product of these two parameters is the bed's heat transfer coefficient on a bed volume basis:

Volumetric heat transfer coefficient:

$${h}_{v} = \frac{BTU}{( {ft}^{3} Bed ) ( °F ) ( s )} or = \frac{kcal}{( L Bed ) ( °C ) ( s )}$$

The heat transfer coefficients are sensitive to a variety of gas properties, including flow rate and composition. Coefficients are typically higher during reforming because the hydrogen in the gas has very high thermal conductivity. Coefficients are typically increased by decreasing the characteristic size of the packing (e.g., hence ⅛″ beads will have higher hᵥ than ½″ beads).

The heat of reforming of hydrocarbons is well known, and can be expressed on a basis of units of heat per standard volume of hydrocarbon gas. The heat transfer requirement for this PSR system can be expressed as the product of volumetric heat of reforming with the GHSV of the feed.

Volumetric heat transfer requirements of the system are expressed as:

$$H = \frac{GHSV \cdot Δ {H}_{REF}}{3600 s \text{/} hr} = \frac{BTU}{( {ft}^{3} Bed ) ( s )} or = \frac{kcal}{( L Bed ) ( s )}$$

In this equation, GHSV and ΔH_{REF} have substantially identical units of feed amount. Thus, if the units of GHSV are as NL/hr of C₁ per L bed, then the units of ΔH_{REF} are heat of reaction per NL of C₁.

A heat transfer delta-temperature ΔT_{HT}, is also used herein to characterize the PSR system, as taught herein. ΔT_{HT} is defined herein as the ratio of volumetric heat transfer requirement to volumetric heat transfer coefficient. Characteristic heat transfer ΔT_{HT}=H/hᵥ.

This characteristic ΔT_{HT} describes the balance between heat transfer supply and demand. As used herein, the ΔT_{HT} is calculated using heat transfer coefficients based on typical regeneration conditions. The characteristic ΔT_{HT} is a basic design parameter for the present invention. Packing or space velocity are chosen to satisfy characteristic ΔT_{HT} requirements of this invention.

In the practice of this embodiment, the characteristic ΔT_{HT} should be between about 0.1° C. and about 500° C. More preferably, the characteristic AT should be between about 0.5° C. and 40° C.

As an example, if a packing has a heat transfer coefficient of 10 BTU/ft³s° F., then given a methane heat of reforming of 248 BTU/scf the C₁GHSV achievable at a characteristic ΔT_{HT} of 40° C., would be ˜1.5×10⁴ hr ⁻¹. Given bed-packing materials that are presently known in the art, including particulate packing, and foam and honeycomb monoliths, the present invention can be operated at high efficiency at a space velocity up to about 100,000 hr⁻¹.

In a preferred embodiment the bed packing material will have several characteristics. It will have the ability to cycle repeatedly between high (e.g., ≧1000° C.) and low (e.g., ≦600° C.) temperatures, provide high wetted area (e.g., ≧6 cm⁻¹) and volumetric heat transfer coefficient (e.g., ≧0.02 cal/cm³s° C., preferably ≧0.05 cal/cm³° C., and most preferably ≧0.10 cal/cm³s° C.), have low resistance to flow (i.e., low pressure-drop), have operating temperature consistent with the highest temperatures encountered during regeneration, and have high resistance to thermal shock. Furthermore, it is preferred that the material has high bulk heat capacity (e.g., ≧0.10 cal/cm³° C. and preferably ≧0.20 cal/cm³° C.). Additionally, the bed packing material will provide sufficient support for the reforming catalyst in the reforming bed. These requirements are met via control of the shape, size, and composition of the bed packing materials.

The shape and size of the bed packing material impact the beds heat transfer capability and flow resistance. This is because packing shape and size impact how the fluid flows through the packing, including, most importantly, the size and turbulence in the fluid boundary layers that are the primary resistance to heat, mass and momentum transfer between fluid and solid. Furthermore, the size of the materials also impacts thermal shock resistance of the bed, because larger structures are typically susceptible to thermal shock. The shape impacts bed heat capacity through its relationship on bed void volume. The design of advantageous packing shapes to achieve these aspects of the invention is well know in the art.

Examples of suitable packing materials include honeycomb monoliths and wall-flow monoliths, which have straight channels to minimize pressure drop and enable greater reactor length. Preferred honeycomb monoliths for the present invention will have channel densities that range from about 100 channels/in² to about 3200 channels/in² (15-500 channels/cm²). In an alternate embodiment more tortuous packing, such as foam monoliths and packed beds may be employed. Preferred foam monoliths for the present invention will have pore densities that range from about 10 ppi (pores per inch) to about 100 ppi (i.e., 4-40 pore/cm). Preferred packed beds for the present invention will have packing with wetted surface area that range from about 180 ft⁻¹ to about 3000 ft-⁻¹ (i.e., 6 - 100 cm⁻¹).

The composition of the bed packing material is important to operating temperature and thermal shock resistance. Thermal shock resistance is generally greatest for materials having low coefficients of thermal expansion, because it is the temperature-induced change in size that stresses a component when temperatures are changing due to cycling. Ceramic materials have been developed that are resistant to combustion temperatures and thermal shock, particularly for application in engine exhaust filters and regenerative thermal oxidizers. Cordierite materials (magnesium aluminum silicates) are preferred for their very low coefficients of thermal expansion. Preferred materials of construction include aluminum silicate clays, such as kaolin, aluminum silicate clay mixed with alumina, or aluminum silicate clay and alumina mixed with silica and optionally zeolites. Other candidate materials of construction include mullite, alumina, silica-alumina, zirconia, and generally any inorganic oxide materials or other materials stable to at least 1000° C. The materials may be used alone or in combination, and may have their structures stabilized, for example by use of rare earth additives. The bed packing materials of the regenerating zone can either be the same or different from the packing materials of the reforming zone.

The configuration of the beds within the reforming and recuperating zones may take the many forms that are known in the art. Acceptable configurations include horizontal beds, vertical beds, radial beds, and co-annular beds. Packing may be monolithic or particulate in design. Particulate packing may become fluidized during some steps of the present invention. In a preferred embodiment, bed packing is maintained in a fixed arrangement.

Suitable reforming catalysts include noble, transition, and Group VIII components, as well as Ag, Ce, Cu, La, Mo, Mg, Sn, Ti, Y, and Zn, or combinations thereof, as well as other metal and non-metal materials added to stabilize and/or enhance catalytic performance. As used herein above, the term component relates to a metal or metal oxide thereof. Preferred catalyst systems include Ni, NiO, Rh, Pt, and combinations thereof. These materials may be deposited or coated on, or in, catalyst supports well known in the art.

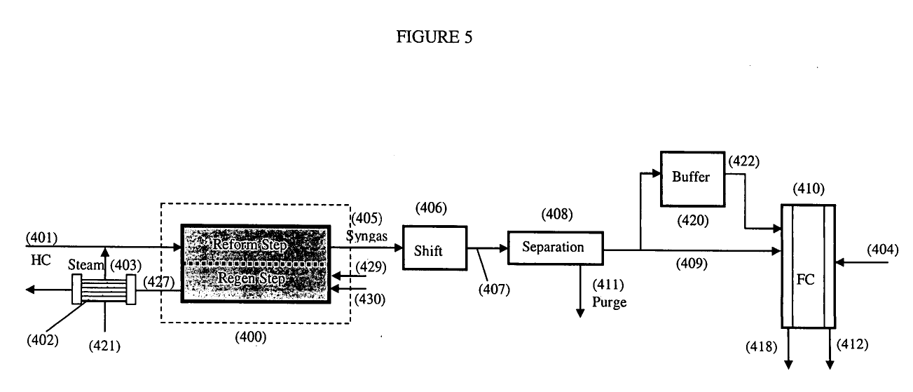

FIG. 4 diagrammatically illustrates the pressure swing reforming process described above to supply hydrogen fuel to a fuel cell (310) and a hydrogen buffer (302. The PSR unit (300) may include single or multiple beds, with the details of valving and flow control all contained within the unit (300, and not further detailed in FIG. 4. Referring to the figure, a hydrocarbon containing feed (301) such as gasoline, and steam (303) are supplied to the reforming step of the PSR reactor (300), where the feed gases are converted to a synthesis gas (305) using the pressure swing reforming process previously described. The synthesis gas generally comprises CO, CO₂, H₂, H₂O and residual hydrocarbon gases. The synthesis gas produced by PSR is at a relatively high pressure, typically ranging from about zero (0) atmospheres gauge to about twenty five (25) atmospheres, and preferably from about four (4) atmospheres to about fifteen (15) atmospheres.

There are several different types of fuel cells known in the art, and each imposes different restrictions on the fuel properties. The synthesis gas from the PSR reactor may be used as the fuel for a fuel cell, or may be subject to additional processes that may be needed to adjust the effluent composition to those of the fuel cell input. For example, a low temperature Polymer Electrolyte Fuel Cell (PEFC), common in vehicle applications, requires a hydrogen stream that contains very small concentrations of CO (typically <100 ppm), but may contain large concentrations of inert gases such as nitrogen and CO₂. The CO content of the PSR effluent would be reduced through either chemical conversion—for example, by water-gas shift—or through separation for such fuel cell application. A high-temperature solid-oxide fuel cell (“SOFC”), would not require these processes, and the PSR effluent could be used without further modification directly in the cell (302. Other fuel cells that may be used with PSR include alkaline fuel cells, molten carbonate fuel cells, and phosphoric acid fuel cells. As shown in FIG. 4, a portion of the hydrogen from reformer (300) is stored in hydrogen the buffer (302) for delivery to fuel cell (310 during start-up or when transient demand requires H₂.

The embodiment illustrated in FIG. 4 employs a fuel cell (310 that is tolerant of PSR-produced synthesis gas components that accompany the hydrogen produced (such as CO, for example), and may utilize the synthesis gas (305) as produced by the PSR reactor (300). Although not illustrated in the figure, alternatively, a synthesis gas adjustment step (not shown) may be integrated to convert one or more of the synthesis gases to gases used or tolerated by fuel cell (310. For example, one or more water gas shift reaction steps, known in the art, may be used to convert carbon monoxide in the synthesis gas into carbon dioxide, which is more tolerable to conventional fuel cells. Additionally, a preferential oxidation process step may be used to reduce CO levels by oxidation to CO₂. Suitably preferential oxidation processes are also known in the art.

The regeneration step of the PSR, as described previously, is accomplished using an oxygen-containing stream (330 and a fuel stream (329), and producing a fluegas stream (327). Operation of the fuel cell results in exhaust of O₂-depleted air (312) from the cathode and H₂-depleted syngas (318) from the anode.

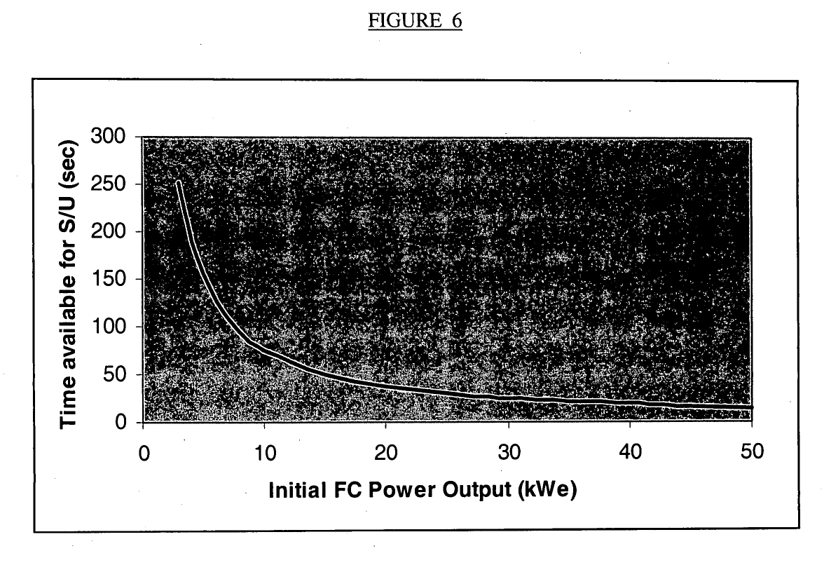

FIG. 5 illustrates the pressure swing reforming process described previously with a water-gas shift reaction followed by hydrogen separation. Referring to the figure, a hydrocarbon containing feed (401) and steam (403) are supplied to the reforming step of the PSR reactor (400), where the feed gases are converted to synthesis gas (405) generally comprising CO, CO₂, H₂, H₂O and residual hydrocarbon gases. In one embodiment the synthesis gas is optionally fed to a shift reactor (406) where CO levels are reduced by conversion to CO₂ and additional hydrogen is produced. An excess amount of steam may be provided to the PSR reforming step to satisfy steam requirements for the water-gas shift reaction. Alternatively, steam may be supplied to the water-gas shift reaction to promote the reaction illustrated in formula 2. The shift reaction is a process well known in the art, and as previously noted, may be conducted in one or more steps. For example, a single stage shift reaction may be conducted at temperatures of about 250° C. to about 400° C. in the presence of a shift catalyst, such as iron oxide-chromium oxide catalyst for example. Notably, the shift reaction does not substantially alter the pressure of the synthesis gas produced by PSR.

The synthesis gas (405), or optionally the shift reaction product (407) is fed to a hydrogen separator (408), which may comprise alternative hydrogen separation means. In one embodiment, the hydrogen separation means comprises a membrane configured to withstand the temperatures and pressures exhibited by the process gas stream, while having a relatively high permeance to hydrogen and low permeance to synthesis gas components other than hydrogen. The separator results in a hydrogen concentrate (409) and a purge stream (411). A portion of the hydrogen concentrate (409) is fed to hydrogen buffer (420) with the balance to fuel cell (410). During start-up or when the fuel cell (410) requires additional hydrogen, hydrogen from the buffer (420) is supplied by live (422) to the fuel cell (410).

Alternative separation technologies may be used for separating hydrogen from the other constituents of the synthesis gas. Membrane separation, pressure and temperature swing adsorption, and absorption systems provide suitable hydrogen separation and are generally known in the art. In one preferred embodiment, the hydrogen separator (408) is a membrane system comprising a metallic membrane such as palladium or vanadium.

Alternative membrane embodiments are known to those skilled in the art, and generally comprise inorganic membranes, polymer membranes, carbon membranes, metallic membranes, composite membranes having more than one selective layer, and multi-layer systems employing non-selective supports with selective layer(s). Inorganic membranes may be comprised of zeolites, preferably small pore zeolites, microporous zeolite-analogs such as AlPO's and SAPO's, clays, exfoliated clays, silicas and doped silicas. Inorganic membranes are typically employed at higher temperatures (e.g., >150° C.) to minimize water adsorption. Polymeric membranes typically achieve hydrogen selective molecular sieving via control of polymer free volume, and thus are more typically effective at lower temperatures (e.g., <200° C.). Polymeric membranes may be comprised, for example, of rubbers, epoxies, polysulfones, polyimides, and other materials, and may include crosslinks and matrix fillers of non-permeable (e.g., dense clay) and permeable (e.g., zeolites) varieties to modify polymer properties. Carbon membranes are generally microporous and substantially graphitic layers of carbon prepared by pyrolysis of polymer membranes or hydrocarbon layers. Carbon membranes may include carbonaceous or inorganic fillers, and are generally applicable at both low and high temperature. Metallic membranes are most commonly comprised of palladium, but other metals, such as tantalum, vanadium, zirconium, and niobium are known to have high and selective hydrogen permeance. Metallic membranes typically have a temperature- and H₂-pressure-dependent phase transformation that limits operation to either high or low temperature, but alloying (e.g., with Cu) is employed to control the extent and temperature of the transition. Most typically, metallic membranes are used between about 200° C. and about 500° C.

In preferred embodiments, the PSR process produces relatively high-pressure syngas that is particularly well suited to a membrane separation system. The rate of hydrogen permeation of the membrane is increased directly with hydrogen partial pressures. Accordingly, relatively high rates of permeation of hydrogen fuel (409) are accomplished through the use of PSR, resulting in increased hydrogen fuel (409) produced for use by fuel cell (410), and resulting in decreased amounts of hydrogen rejected in the separation's purge stream (411) with the non-hydrogen fraction of the synthesis gas.

The regeneration step of the PSR is fed with fuel (429) and oxygen-containing (430) streams, and results in a fluegas stream (427). At least a part of fuel (429) is supplied from PSR generated synthesis gas. In a preferred embodiment, fuel (429) for the regeneration step is supplied by the separation purge (411), fuel cell anode exhaust (418), or a combination thereof. The flue gas stream (427) is at a temperature that is comparable to the temperature remaining in the reforming zone of the PSR at the end of the reforming step. In embodiments such as described in FIG. 4, in which the reforming feed H₂O is introduced as steam, that reforming zone temperature is dictated by the kinetics of the steam reforming reaction. This is because, during the reforming step, reaction will consume heat until the temperature is too low for the kinetics, and then heat will no longer be consumed. Typically, this results in an average flue gas stream (427) temperature of about 400° C. to 500° C. In the embodiment shown in FIG. 4, the heat content of this fluegas stream is used to provide the enthalpy of vaporization for the water (421) that is used to make the reforming feed steam (403). A heat exchanger, also called a steam boiler (402), is used to transfer the heat of the fluegas into the H₂O stream. In a preferred embodiment, a vapor recovery device (not shown) coupled to the cathode exhaust (412) of the fuel cell, supplies water to steam boiler (402).

### EXAMPLES

The following examples illustrate the advantages of a fuel processor with hydrogen buffering.

### Example 1

### Power During Start-Up

FIG. 6 shows the maximum time over which hydrogen can be drawn from a hydrogen buffer, as a function of fuel cell power output. In this example a hydrogen buffer of size 10 liters storing hydrogen at 15 atm is used in conjunction with a 50% efficient fuel cell system having 50 kWe maximum power and operating at ambient pressure. This time reflects the duration that the fuel cell can be operated before hydrogen input from the reforming system is required, and thus represents the time available for processor startup. The available time for processor start-up and hydrogen rich gas production will vary with the size of the buffer and the maximum pressure at which the hydrogen gas is stored. For larger buffer size and/or higher storage pressures available start-up time will increase at a given initial sustained power output from the fuel cell system.

### Example 2

### Turndown and Transients

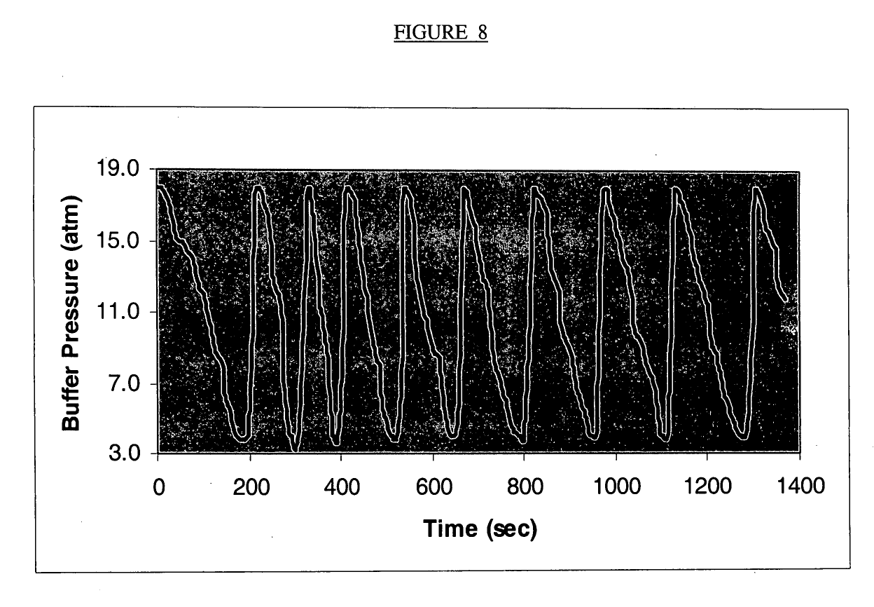

In this example, the hydrogen demand of a fuel processor (˜0.9 g/sec H₂ maximum output), that is connected to a fuel cell system for operating, over automobile drive-cycle is moderated via the hydrogen buffer of 10 liter size capable of storing hydrogen at pressures up to 20 bars. The fuel processor is assumed to take 30 seconds to heat-up and start producing hydrogen. It is further assumed that the fuel processor is capable of operating only in two modes, ON (full power or maximum H₂ output) and OFF (zero power or zero H₂ output). The hydrogen demand from the fuel cell is met by supplying hydrogen from the buffer and as the buffer pressure falls below certain set value (4 bars), the fuel processor is turned ON to produce H₂ at its 100% rated value and fill the buffer. Once the buffer pressure builds up to a certain pressure (18 bars) the fuel processor is turned OFF. FIG. 7 shows hydrogen supply to buffer from the processor and demand from the fuel cell over time and FIG. 8 shows the variation in buffer pressure over time.

What is claimed is:

1. A fuel cell system comprising:
a fuel cell;
a hydrocarbon fuel processor for generating hydrogen for use in the fuel cell; and
a hydrogen buffer for storing a portion of the hydrogen produced in the fuel processor for use by the system during start-up of the system or when required by the fuel cell during the course of operation of the system.

2. The system of claim 1 wherein the fuel processor is a steam reformer.

3. The system of claim 2 wherein the steam reformer is a pressure swing reformer.

4. The system of claim 3 including water gas shift reactor for increasing the hydrogen produced in the pressure swing reformer.

5. The system of claim 4 including a gas separator for separating the hydrogen obtained from the shift reactor.

6. The system of claim 5 wherein the buffer is sized to store sufficient hydrogen for use by the system during start-up.

7. The system of claim 5 wherein no buffer is sized to store sufficient hydrogen for use by the system during start-up and when, during the course of operating the system, the hydrogen generated by the fuel processor is temporarily less than the operating demand of the fuel cell.

8. A method for supplying hydrogen fuel for a fuel cell comprising: generating hydrogen in a hydrocarbon fuel processor;
storing a portion of the hydrogen produced in the fuel process;
supplying the balance of the hydrogen produced in the fuel processor to the fuel cell;
supplying stored hydrogen to at least one of: (i) the fuel cell during start-up; (ii)
the fuel processor during start-up for burning and heating the components; and
(iii) when the amount of hydrogen generated by the fuel processor is temporarily less than the operating demand of the fuel cell.

9. The method of claim 7 including wherein the hydrogen is generated in a pressure serving reformer.

10. The method of claim 8 including treating the hydrogen from the pressure during reformer to a water gas shift reactor to increase the amount of hydrogen generated.

11. The method of claim 9 including separating the hydrogen generated in the water gas shift reactor.
